(19) United States
(12) Patent Application Publication
(10) Pub. No.: US 2014/0354258 A1
(43) Pub. Date: Dec. 4, 2014

(54) SUPPLY VOLTAGE CIRCUIT

(71) Applicant: Silicon Laboratories Inc., Austin, TX (US)

(72) Inventor: Axel Thomsen, Austin, TX (US)

(21) Appl. No.: 13/905,260

(22) Filed: May 30, 2013

(51) Int. Cl. H02M 3/156

(52) U.S. Cl. CPC H02M 3/1563
USPC 323/299

(57) ABSTRACT

A method includes using a charge pump to receive a first supply voltage and generate a voltage in response thereto. The method includes using the voltage generated by the charge pump to bias a supply voltage circuit to generate a second supply voltage. The second supply voltage is greater than the first supply voltage.

### BACKGROUND

An electrical system (an integrated circuit, a computer system or a microcontroller, as examples) may contain transistors that ideally function as switches for purposes of electrically coupling nodes together, forming logical gates, and so forth. A metal oxide semiconductor field-effect-transistor (MOSFET) is one such transistor, which may be fabricated using a complimentary metal-oxide-semiconductor (CMOS) process.

For purposes of operating a transistor as an ideal switch, a control signal may be provided to the transistor, and this control signal may have one of two states: a first state to cause the transistor to “turn on,” or establish a current path; and a second state to cause the transistor to “turn off,” or remove the current path. As a more specific example, an n-channel MOSFET (nMOS transistor) may be turned on and off by controlling a gate-to-source (V_{GS}) voltage of the nMOS transistor. When the V_{GS} voltage is above a certain threshold voltage, an inversion layer, or channel, is formed in the nMOS transistor, which establishes a current path between the drain and source of the nMOS transistor (as a function of the circuit coupled to the nMOS transistor) to “turn on” the nMOS transistor. Conversely, when the V_{GS} voltage is below the threshold voltage, the channel is removed, thereby electrically isolating the nMOS transistor's drain and source to “turn off” the nMOS transistor.

### SUMMARY

In an example embodiment, a method includes using a charge pump to receive a first supply voltage and generate a voltage in response thereto. The method includes using the voltage generated by the charge pump to bias a supply voltage circuit to generate a second supply voltage. The second supply voltage is greater than the first supply voltage.

In another example embodiment, an apparatus includes a first charge pump, a second charge pump and a supply voltage circuit. The first charge pump is adapted to provide a first voltage. The supply voltage circuit includes an output stage circuit to provide an output voltage for the supply voltage circuit. The supply voltage circuit is adapted to bias the output stage circuit in response to the first voltage and use the second charge pump to provide an output current for the output stage.

In yet another example embodiment, an apparatus includes an integrated circuit that includes a charge pump and a supply voltage circuit. The charge pump is adapted to boost a first supply voltage to generate a second voltage, and the supply voltage circuit is adapted to be biased in response to the second voltage to generate a second supply voltage, which is greater than the first supply voltage.

Advantages and other desired features will become apparent from the following drawings, description and claims.

### BRIEF DESCRIPTION OF THE DRAWINGS

FIG. 1 is a schematic diagram of a microcontroller unit (MCU)-based system according to an example embodiment.

FIG. 2 is a schematic diagram of an MCU according to an example embodiment.

FIG. 3 is a schematic diagram of a supply voltage circuit of the MCU of FIG. 2 according to an example embodiment.

FIG. 4 is a flow diagram depicting a technique to generate a supply voltage according to an example embodiment.

FIG. 5 is a schematic diagram of a supply voltage circuit of the MCU of FIG. 2 according to a further example embodiment.

FIG. 6 is a flow diagram depicting a technique to generate a supply voltage according to a further example embodiment

FIG. 7 is a schematic diagram of an output circuit of a supply voltage circuit according to an example embodiment.

FIG. 8 is a schematic diagram of an MCU-based motor control system according to an example embodiment.

FIG. 9 is a schematic diagram of a supply voltage circuit of the MCU of FIG. 2 according to a further example embodiment.

### DETAILED DESCRIPTION

An electrical system (a computer system, an integrated circuit, or a microcontroller, as examples) may contain at least one transistor that is operated as an electrically-controlled switch, i.e., switched “on” (i.e., is placed in a conductive state) and “off” (i.e., placed in a non-conductive state) by controlling the state of a control signal that is received by the transistor. Such a transistor may form a logic gate, a pass gate, a switch, and so forth, for the electrical system, depending on the particular application. As a more specific example, the transistor may be a metal oxide semiconductor field-effect-transistor (MOSFET), which has an associated threshold voltage that controls whether a control voltage that is applied to the MOSFET places the MOSFET in a conductive or non-conductive state.

More specifically, for an n-channel MOSFET (nMOS transistor), a threshold voltage (often called the “V_{TN}” voltage) of the nMOS transistor controls whether or not the nMOS transistor conducts current between its drain and source. In this manner, when the gate-to-source voltage (or “V_{GS}” voltage) exceeds the V_{TN} threshold voltage, an inversion layer, or channel, is formed in the nMOS transistor, which creates a current path between the drain and source of the nMOS transistor. Otherwise, for a V_{GS} voltage below the V_{TN} threshold voltage, the channel and current path are not formed between the drain and source. In a similar manner, a p-channel MOSFET (pMOS transistor) has a threshold voltage (called “V_{TP}”) which controls whether the pMOS transistor conducts or not. In this manner, when the V_{GS} voltage of a pMOS transistor is above the V_{TP} threshold voltage, the pMOS transistor does not conduct. However, when the V_{GS} decreases below the V_{TP} voltage, a channel is formed between the source and drain of the pMOS transistor, which forms a corresponding current path.

When conducting, the MOSFET may be placed either in an Ohmic mode in which the voltage across the drain-source current path generally resistively varies with the magnitude of the current in the path; or in an active, or saturation mode, in which the voltage across the drain-source current is generally independent of the magnitude of the current in the drain-source path.

The magnitude of the drain-source voltage of the MOSFET relative to the magnitude of its gate-source voltage determines whether the MOSFET is in the saturation mode or in the Ohmic mode. More specifically, for the nMOS transistor to be in the saturation mode (as opposed to the Ohmic mode), the V_{DS} drain-to-source voltage of the nMOS transistor exceeds a certain threshold defined by the gate-to-source and threshold voltages, as described below:

V_{DS}>V_{GS}−V_{TN}, Eq. 1

For the pMOS transistor to be in the saturation mode, the V_{SD} source-to-drain voltage exceeds a certain threshold, as described below:

V_{SD}>V_{SG}−V_{TP}, Eq. 2

where the “V_{SG}” represents the source-to-gate voltage.

Whether or not a given MOSFET is turned on (in the saturation or Ohmic modes of operation), turned off or placed in a high impedance state may be a function of the supply voltage(s) of the electrical system containing the MOSFET, as the drain-to-source/source-to-drain voltage is a function of the supply voltage magnitude. In other words, below a certain supply voltage differential, the transistor may be placed in a high impedance state, although the transistor may receive a gate-to-source voltage (for an nMOS transistor) or source-to-gate voltage (for a pMOS transistor) to otherwise turn on the transistor.

Systems and techniques are disclosed herein for purposes of generating one or multiple supply voltages from a lower supply voltage that is provided to an electrical system for purposes of operating the system's transistors as intended by their gate-to-source and source-to-gate voltages. More specifically, in accordance with example embodiments that are disclosed herein, the electrical system includes a supply voltage circuit; and the supply voltage circuit contains one or more charge pumps that are constructed to boost a supply voltage that is provided to the electrical system for purposes of generating one or more boosted voltages. An output stage of the supply voltage circuit uses the boosted voltage(s) to provide one or more boosted supply voltages for components of the electrical system, in accordance with example embodiments.

A particular advantage of a boosted supply voltage is that transistors, such as MOSFETs, that are coupled to the supply voltage are fully turned “on,” operate in saturation or Ohmic modes of operation, and thereby more closely emulate switches, as compared to transistors, for example, that may be coupled to a lower supply voltage. For example, for a circuit containing nMOS transistors and pMOS transistors, the systems and techniques that are disclosed herein have the advantage of boosting a power supply voltage that may be less than the sum of the V_{TN} and V_{TP} threshold voltages to a supply voltage that is sufficient to operate the nMOS transistors and pMOS transistors in Ohmic or saturation modes of operation. Another particular advantage is that a boosted supply voltage allows a transmission gate having an input voltage (VIN_TG) to turn on when a supply voltage (VSUPP) is less than V_{TN}+V_{TP}, V_{TP} is greater than VIN_TG, and VIN_TG is greater than VSUPP-VIN_TG.

As a more specific example, FIG. 1 depicts a microcontroller unit (MCU) 24 of an example system 10. The MCU 24 includes a supply voltage circuit 250, which receives a supply voltage that is provided to the MCU 24 and provides at least one internal supply voltage for components of the MCU 24, which is greater in magnitude than the received supply voltage.

Although an MCU is disclosed herein as an example embodiment of an electrical circuit/system that includes a supply voltage circuit that provides a boosted supply voltage, it is understood that the systems and techniques that are disclosed herein may be applied to other circuits and systems (an integrated circuit not containing an MCU, a computer system, an integrated circuit other than one containing an MCU, and so forth), in accordance with other example embodiments.

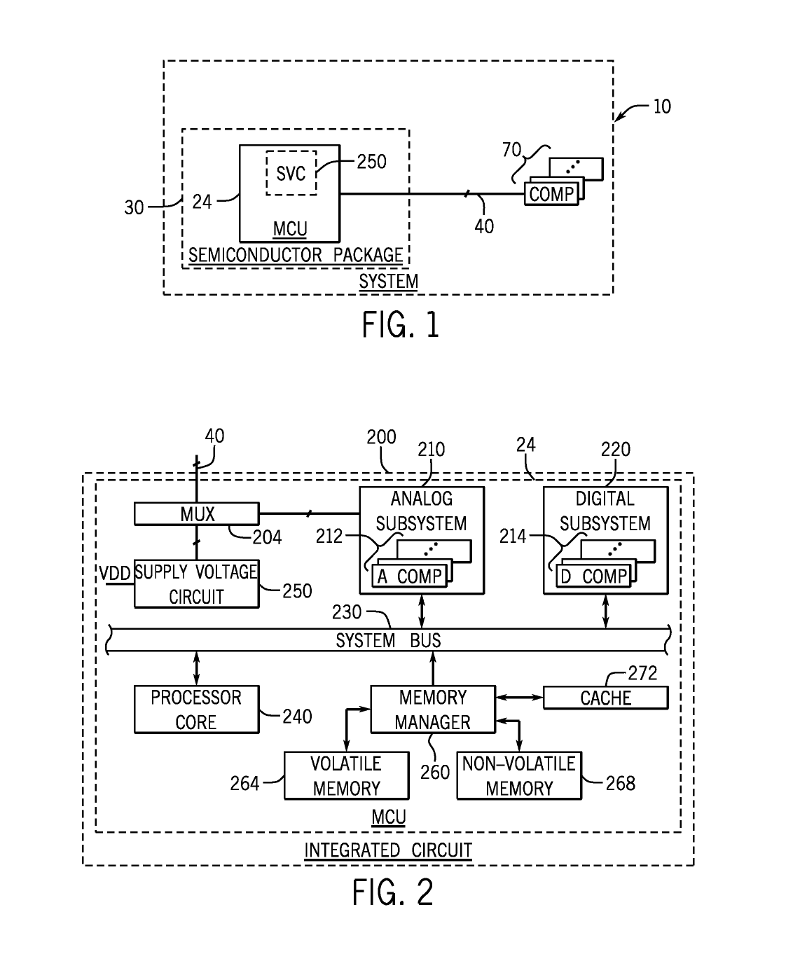

For the example embodiment that is depicted in FIG. 1, the MCU 24 controls various aspects of one or multiple components 70 of the system 10. As examples, the components 70 may include one of more of the following depending on the particular application in which the MCU 24 is used: an electrical motor, a household appliance, an inventory control terminal, a computer, a tablet, a smart power meter, a wireless interface, a cellular interface, an interactive touch screen user interface and so forth. All or part of the components of the MCU 24 may be part of an integrated circuit (IC) 200 (see FIG. 2) that may be packaged to form the semiconductor package 30 (see FIG. 1). For example, all or part of the components of the MCU 24 may be fabricated on a single die or on multiple dies (a multi-chip module, for example) of the IC 200.

Referring to FIG. 2, in general, the supply voltage circuit 250 of the MCU 24 receives a supply voltage (called “VDD” in FIG. 2) and boosts the VDD voltage to provide one or more supply voltages for various components of the MCU 24, such as, for example, a processor core 240 and a multiplexer 204, which selectively couples analog components 212 (of an analog subsystem 210) to selected I/O terminals 40 of the MCU 24. For example, the multiplexer 204 may be operated by the MCU 24 for purposes of selectively coupling ports of the MCU 24 to an analog-to-digital converter (ADC) of the analog subsystem 210. It is noted that the components of the MCU 24 receiving supply voltage(s) from the supply voltage circuit 250 may include the analog components 212 as well as various other components of the MCU, such as digital components 214 (of a digital subsystem 220) and other components of the MCU 24. Depending on the particular embodiment, the MCU 24 may not contain any of the components depicted in FIG. 2 other than the processor core 240 and the supply voltage circuit 250; may contain one or more of the components that are depicted in FIG. 2 in addition to the processor core 240 and the supply voltage circuit 250; may contain other and/or additional components other than the components that are depicted in FIG. 2; and so forth. Thus, many embodiments are contemplated, which are within the scope of the appended claims.

As an example, the processor core 240 may be a 32-bit core, such as the Advanced RISC Machine (ARM) processor core, which executes a Reduced Instruction Set Computer (RISC) instruction set. In general, the processor core 240 communicates with various other system components of the MCU 24, such as a memory controller, or manager 260, over a system bus 230. In general, the memory manager 260 controls access to various memory components of the MCU 24, such as a cache 272, a non-volatile memory 268 (a Flash memory, for example) and a volatile memory 264 (a static random access memory (SRAM), for example).

It is noted that FIG. 2 depicts an exemplary or simplified representation of the MCU architecture, as the MCU 24 may have many other components, bridges, buses, and so forth, in accordance with further embodiments, which are not depicted in FIG. 2. For example, in accordance with some embodiments, the MCU 24 may have a bus matrix module that implements slave side arbitration and is used to regulate access to the memory devices of the MCU 24.

In accordance with some embodiments, the analog 210 and digital 220 subsystems may communicate analog and digital signals with corresponding input/output (I/O) terminals of the MCU 24. In general, the analog subsystem 210 include analog components 212, which receive and/or provide analog signals, such as analog-to-digital converters (ADCs), analog sampling circuits, digital-to-analog converters (DACs), comparators, current drivers, voltage translators, current drivers and so forth.

The digital components of the digital subsystem 220 may communicate with the processor core 240 over the system bus 230. As examples, the digital components 214 may include a Universal Serial Bus (USB) interface, a universal asynchronous receiver/transmitter (UART), a system management bus interface (SMB), a serial peripheral interface (SPI), a clock generator module, programmable timers and so forth. In general, the digital components 214 may communicate with devices that are external to the MCU 24 via corresponding I/O terminals.

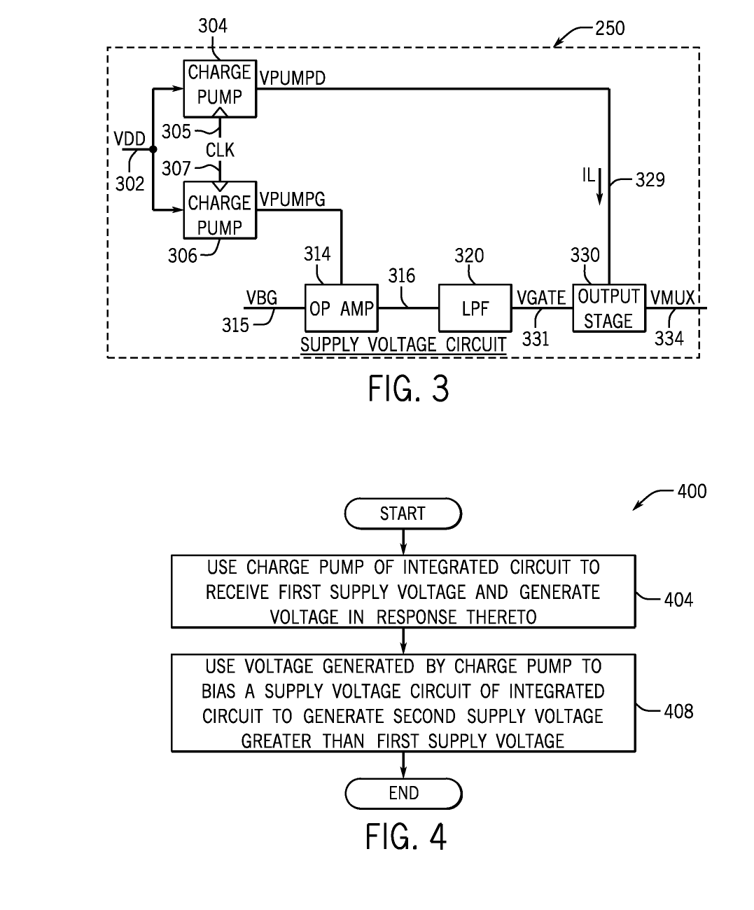

Referring to FIG. 3, in accordance with an example embodiment, the supply voltage circuit 250 includes two charge pumps 304 and 306, which boost the VDD supply voltage (communicated to the MCU 24 via a supply voltage rail 302) to produce respective voltages that are used by the supply voltage circuit 250 to generate at least one boosted supply voltage, such as a VMUX output supply voltage that is depicted in FIG. 3 and appears at an output 334 of the supply voltage circuit 250. In this manner, the charge pump 304 provides a boosted voltage (called “VPUMPD” in FIG. 3 and being provided to a supply rail 329), which is used as a supply voltage for an output stage 330 of the supply voltage circuit 250; and the charge pump 306 generates a boosted voltage (called “VPUMPG” in FIG. 3), which is used by circuitry of the supply voltage circuit 250 (as described further herein) to generate a bias voltage (called “VGATE” in FIG. 3) for the output stage 330.

As further disclosed below, the output stage 330 uses the VPUMPD and VGATE voltages to generate its boosted VMUX output voltage at the output 334. Due to the VPUMPD voltage being used as a supply rail voltage for the output stage 330, the charge pump 304 further provides a supply current (called “I_{L}” in FIG. 3) which is delivered to the load via the output 334.

As a more specific example, in accordance with an example embodiment, each charge pump 304 and 306 is a two times, or “2×,” charge pump. The charge pumps 304 and 306, in accordance with an example embodiment, operate independently from each other and operate open loop to provide respective output voltages that each have a magnitude that is approximately twice the magnitude of the VDD supply voltage. In other words, the VPUMPD voltage is approximately twice the VDD supply voltage (the VPUMPD voltage is in a range of 1.5·VDD to 1.99·VDD, for example); and similarly, the VPUMPG voltage is approximately twice the VDD supply voltage (the VPUMPG voltage is a range of 1.5·VDD to 1.99·VDD, for example). As further disclosed herein, the charge pumps 304 and 306 are each clocked by a clock signal (called “CLK” in FIG. 3), which is received at clock inputs 305 and 307, respectively.

In addition to the charge pumps 304 and 306 and the output stage 330, the supply voltage circuit 250 includes a bias generator circuit to generate the VGATE bias voltage in response to the boosted VPUMPG voltage that is provided by the charge pump 306. In this regard, in accordance with example embodiments, the bias generator circuit is formed from an operational amplifier 314 and a low pass filter 320, although the bias generator circuit may have different components and/or a different topology, in accordance with further embodiments.

For the example embodiment that is depicted in FIG. 3, the amplifier 314 receives the VPUMPG voltage at its supply voltage terminal and uses this voltage to power its components. The operational amplifier 314 further includes an input 315, which receives a reference voltage (called “VBG” in FIG. 3). In response to the VBG reference voltage, the operational amplifier 314 provides a bias voltage at its output 316, which is filtered by the low pass filter 320 for purposes of producing the VGATE bias voltage at an input 331 of the output stage 330.

As further disclosed below, the output stage 330 may, in accordance with an example embodiment, receive the VDD supply voltage and furnish the VDD supply voltage (instead of the VMUX supply voltage) at its output 334, depending on the user-selectable configuration of the supply voltage circuit 250. As an example, selection of whether the supply voltage circuit 250 provides the VDD or VMUX supply voltage may be controlled by one or multiple register bits (as programmed by the processor core 240 (see FIG. 2)) or may be controlled by one or multiple external signals that are received by the MCU 24, as just a few example embodiments.

Thus, referring to FIG. 4, in accordance with an example embodiment, a technique 400 includes using (block 404) a charge pump (such as a charge pump of an integrated circuit and/or a charge pump of a processor or processor core, for example) to boost a first supply voltage and generate a voltage in response thereto. The voltage that is generated by the charge pump is used (block 408) to bias a supply voltage circuit (a supply voltage circuit of an integrated circuit containing the charge pump, for example) to generate a second supply voltage that is greater than the first supply voltage.

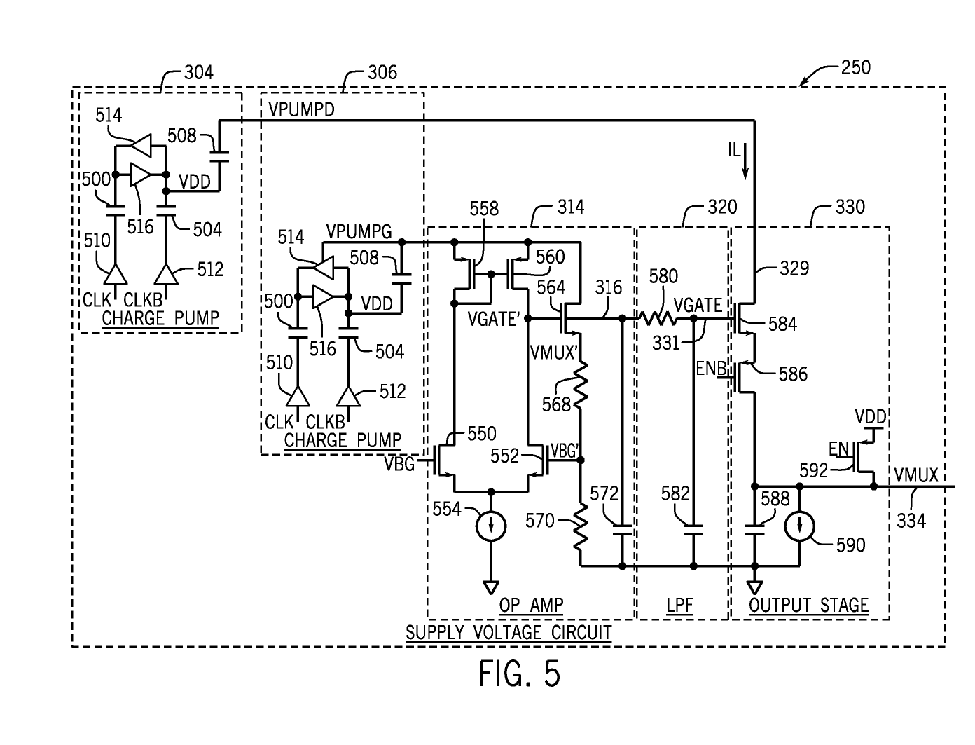

Referring to FIG. 5, in accordance with an example embodiment, the charge pump 304 may include energy storage/transfer devices, such as three capacitors 500, 504 and 508. In this manner, as depicted in FIG. 5, the capacitor 508 is coupled between the VDD supply voltage rail 302 and the VPUMPD rail 329. Due to the switching operation of the charge pump 304, the voltage of the capacitor 508 is maintained near a voltage of 2·VDD, in accordance with an example embodiment.

In with an example embodiment, the charge pump 304 operates in half cycles of the CLK clock signal for purposes of transferring charge to the capacitor 508 to maintain the VPUMPD voltage at the 2·VDD voltage level. For this purpose, during a first half cycle of the CLK clock signal in which the CLK clock signal is asserted (driven to a logic one value, for example), charge is transferred from the capacitor 500 to the capacitor 508; and during this half cycle, charge is stored on the capacitor 504. More specifically, during the half cycle in which the CLK clock signal is asserted, a buffer 512, in response to the inverted CLK clock signal (called the “CLKB” clock signal herein) couples one terminal of the capacitor 504 to ground, and the other terminal of the capacitor 508 is coupled to the V_{DD} supply voltage rail 302 to store charge on the capacitor 504. During the next half cycle, the charge stored on the capacitor 504 is transferred to the capacitor 508 due to the voltage across the capacitor 504 being set to zero. Similarly, during the half cycle of the CLK clock signal in which the CLK clock signal is driven to a logic zero, the VDD voltage is stored across the capacitor 500 to store a corresponding charge on the capacitor 500. During the next half cycle, because the CLK clock signal is driven to the V_{DD} voltage level, charge is transferred from the capacitor 500 to the capacitor 508. As shown in FIG. 5, terminals of the capacitors 500 and 504 are coupled together via back-to-back coupled buffers 514 and 516.

It is noted that the charge pump architecture that is illustrated in FIG. 5 is merely one example of many possible embodiments that may be used for the charge pump.

In accordance with an example embodiment, the charge pump 306 may share a similar design to the charge pump 304, with similar elements being depicted by the same reference numerals.

The operational amplifier 314 may be formed from a differential pair of n-channel MOSFETS (nMOS transistors) 550 and 552, which have their sources coupled together. Moreover, a current sink 554 is coupled between the sources of the nMOS transistors 550 and 552 and ground. The drains of the nMOS transistors 550 and 552 are coupled to a current minor formed from two p-channel MOSFETs (pMOS transistors). In this manner, the drain of the nMOS transistor 550 is coupled to the gate and drain of the pMOS transistor 558, and the source of the MOSFET 558 receives the PUMPG supply voltage. The gate of the pMOS transistor is coupled to the gate of the pMOS transistor 560. The source of the pMOS transistor 560 is coupled to the VPUMPG supply voltage, and the drain of the pMOS transistor 560 is coupled to the drain of the nMOS transistor 552. For this example embodiment, the drain of the pMOS transistor 560 provides a bias voltage (called “VGATE′” herein), which is the bias voltage used to bias the output stage 330, in accordance with an example embodiment.

In accordance with an example embodiment, the operational amplifier 314 is configured as a non-inverting amplifier in which the non-inverting input of the operational amplifier 314 (formed by the gate terminal of the nMOS transistor 552) is coupled to ground through a resistor 570 and is coupled to the drain of the pMOS transistor 560 through an nMOS transistor 564. In this regard, the nMOS transistor 564 has a gate that is coupled to the drain of the pMOS transistor 560, and the source of the nMOS transistor 564 is coupled to the resistor 568. Due to this arrangement, the VGATE′ bias voltage is approximately equal to the product of the VBG reference voltage and the ratio of the resistances of the resistors 568 and 570. The operational amplifier 314 may include a filtering capacitor 572 that is coupled between the drain of the nMOS transistor 552 and ground.

In accordance with an example embodiment, the low pass filter 320 may be formed from a resistor 580 and a capacitor 582. In this regard, in accordance with an example embodiment, the resistor 580 is coupled between gate terminal of the nMOS transistor 564 (i.e., the output of the operational amplifier 314) and the input 331 of the output stage 330. The capacitor 582 is coupled between the input 331 and ground.

In accordance with an example embodiment, the output stage 330 includes an nMOS transistor 584, which has its drain coupled to the VPUMPD voltage, i.e., coupled to the supply rail 329. The nMOS transistor 584 and the presence of the capacitor 582 control (i.e., attenuate) the magnitude of the ripple voltage component of the VPUMPD voltage. The gate of the nMOS transistor 584 forms the input 331 and receives the VGATE bias voltage. The source of the nMOS transistor 584 is coupled to the source of a selection pMOS transistor 586. In this regard, the pMOS transistor 586 has a gate that receives a selection signal (called “ENB” herein), and the drain of the pMOS transistor 586 is coupled to the output 334. Moreover, as depicted in FIG. 5, in accordance with an example embodiment, a capacitor 588 may be coupled between the output 334 and ground, and a current sink 590 may be coupled between the output 334 and ground to provide a bias current. The capacitor 588 provides filtering for the load current and aids in controlled (i.e., attenuating) the ripple component of the VMUX voltage. When the ENB signal is driven to a logic zero value, the pMOS transistor 586 conducts to couple the source of the nMOS transistor 584 (and thus, couple the VPUMPD supply voltage to the output 334).

When the ENB signal is driven to a logic one, however, the pMOS transistor 586 does not conduct, which isolates the output 334 from the VPUMPD supply voltage. When this occurs, in accordance with an example embodiment, the output stage 330 couples the output 334 to the VDD supply voltage. In this manner, as illustrated in FIG. 5, in accordance with example embodiment, a pMOS transistor 592 of the output stage 330 has a gate terminal that receives the inverse of the ENB signal, which is called the “EN” signal herein. The source of the pMOS transistor 592 is coupled to the V_{DD} supply voltage, and the drain of the pMOS transistor 592 is coupled to the output 334. Therefore, when the ENB signal is driven to a logic one value, the EN signal is conversely driven to a logic zero signal, which causes the pMOS transistor 592 to conduct to couple the output 334 to the VDD supply voltage. Conversely, when the EN signal is driven to a logic one value, the pMOS transistor 592 does not conduct, thereby allowing the pMOS transistor 586 and nMOS transistor 584 to couple the output 334 to the VPUMPD supply voltage.

It is noted that a particular advantage of the supply voltage circuit 250 is that the circuit 250 provides a relatively low ripple VMUX output voltage, even when 2·VDD is less than the product of the VBG reference voltage scaled by the ratio of the resistance of resistor 568 to the resistance of the resistor 570. Other and different advantages are possible in accordance with other example embodiments.

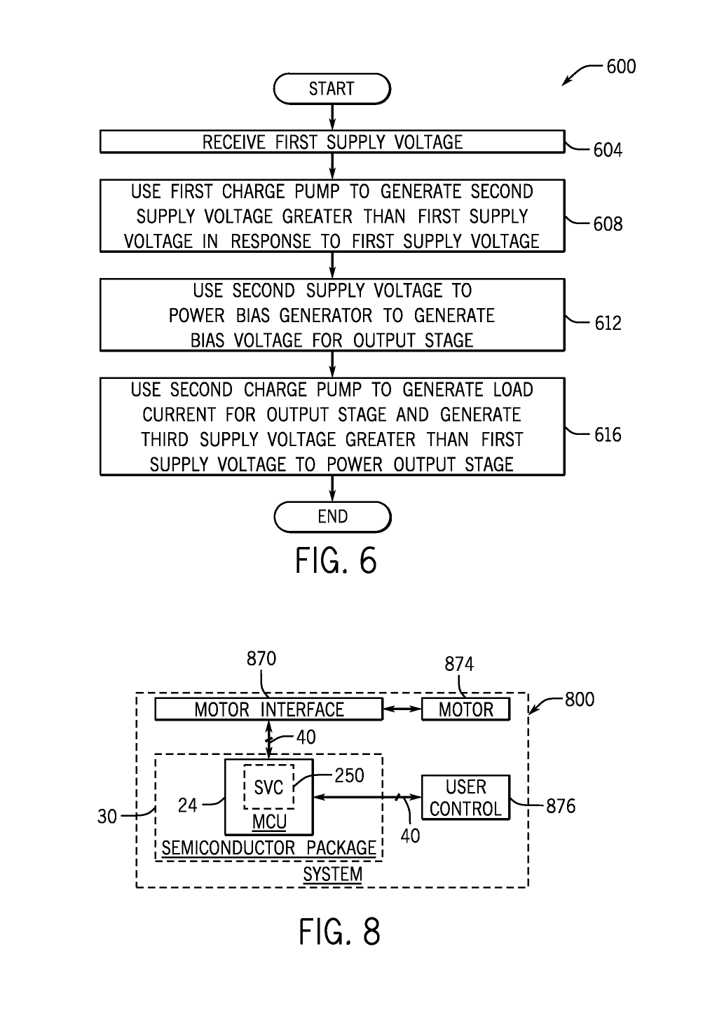

Thus, referring to FIG. 6, in accordance with an example embodiment, a technique 600 includes receiving (block 604) a first supply voltage and using (block 608) a first charge pump to generate a second supply voltage, which is greater than the first supply voltage in response to the first supply voltage. The technique 600 includes using (block 612) the second supply voltage to power a bias generator to generate a bias voltage for an output stage and using (block 616) a second charge pump to generate a load current for the output stage and generate a third supply voltage greater than the first supply voltage.

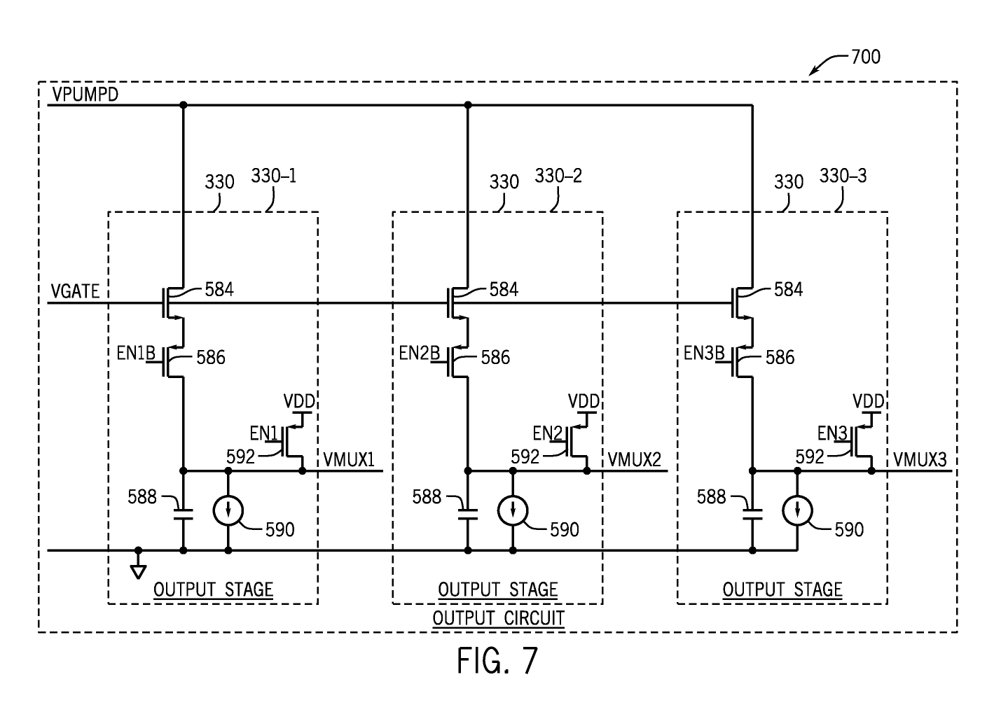

Other embodiments are contemplated, which are within the scope of the appended claims. For example, referring to FIG. 7, in accordance with an example embodiment, the output stage of FIG. 5 may be replaced by multiple output stages 330 (example output stages 330-1, 330-2 and 330-3, being depicted as examples in FIG. 7) in an illustrated alternative output circuit 700. In this regard, for this example embodiment, each output circuit 330 receives the VGATE bias voltage and may be selectively coupled to either the V_{DD} supply voltage or the VPUMPD supply voltage via respective ENB and EN signals. For example, the output stage 330-2 provides an output voltage called “VMUX2,” which may be coupled to either the VDD supply voltage or the VPUMPD supply voltage via associated selection signals EN2 and EN2B.

FIG. 8 depicts a motor control application in which an MCU 24 of a motor control system 800 generates/receives input and output signals (I/O signals) for purposes of controlling a motor 874. In this manner, the MCU 24 may generate signals at its I/O terminals 40 for purposes of communicating with a motor interface 870 (an interface containing drivers, sensors, and so forth); and in connection with this communication, the I/O terminals 40 may communicate waveforms with the motor interface (pulse width modulation (PWM) signals, for example), receive sensed currents and voltages, communicate data via one or more serial buses, and so forth. I/O terminals 40 of the MCU 24 may further generate/receive signals to communicate with a user control interface 876 of the system 800 for such purposes as communicating status of the motor 874 or motor interface 870, communicating detected fault conditions, receiving user-directed commands and signals, and so forth.

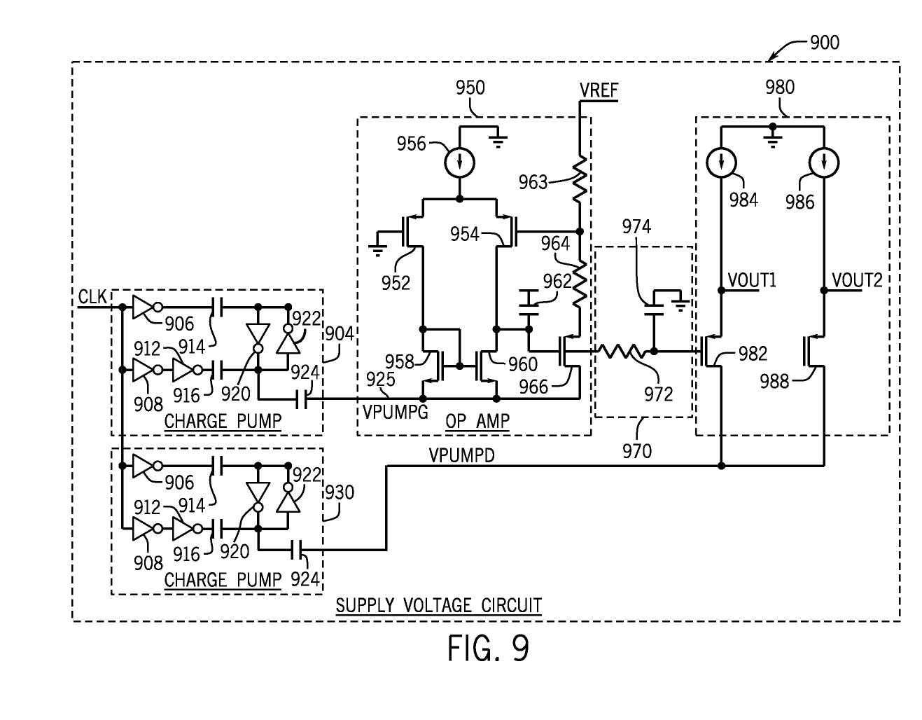

In another example embodiment, FIG. 9 depicts a supply voltage circuit 900, which includes charge pumps 904 and 930 that generate negative supply voltages (VPUMPG and VPUMPD, respectively).

In this regard, as depicted in FIG. 9, the charge pump 904 includes three capacitors 914, 916 and 924. One terminal of the capacitor 924 is coupled to a rail 925 that provides the VPUMPG voltage. Due to the switching operation of the charge pump 904, the voltage across the capacitor 924 (with the rail 925 being the positive reference for the capacitor's voltage) is maintained near a voltage of −·VDD (in a range from −0.7·VDD to −0.99·VDD, as an example range), in accordance with an example embodiment.

In accordance with an example embodiment, the charge pump 904 operates in a half cycles of the CLK clock signal for purposes of transferring charge to the capacitor 924 to maintain the VPUMPG voltage near the −·VDD voltage level (in a range from −0.7·VDD to −0.99·VDD, as an example). For this purpose, during a first half cycle of the CLK clock signal in which the CLK clock signal is asserted (driven to a logic one value, for example), charge is transferred from the capacitor 916 to the capacitor 924; and during this half cycle, charge is stored on the capacitor 914. During the latter half cycle of the CLK clock signal in which the CLK clock signal is asserted (driven to a logic one value, for example), charge is transferred from the capacitor 914 to the capacitor 924, and charge is stored on the capacitor 916. As depicted in FIG. 5, terminals of the capacitors 916 and 914 are coupled together via back-to-back coupled inverters 920 and 922. Moreover, the CLK clock signal is coupled to the capacitor 914 via an inverter 906 and coupled to the capacitor 916 via cascaded inverters 908 and 912.

In accordance with an example embodiment, the charge pump 930 may share a similar design to the charge pump 904, with similar elements being depicted by the same reference numerals.

In accordance with example embodiments, the voltage supply circuit 900 includes a bias generating, operational amplifier 950 that includes a differential amplifier that is formed from pMOS transistors 952 and 954 and a current mirror that is formed from pMOS transistors 958 and 960. In this regard, the sources of the pMOS transistors 952 and 954 receive the current from a current source 956 (which is coupled to ground); the drain of the pMOS transistor 952 is coupled to the drain and gate of the pMOS transistor 958; and the drain of the pMOS transistor 954 is coupled to the drain of the pMOS transistor 960. The sources of the pMOS transistors 958 and 960 are coupled to the VPUMPG rail 925.

In accordance with an example embodiment, the operational amplifier 950 is an inverting gain amplifier, whose gain is −R1/R2·VREF, where “R1” and “R2” are the resistances of feedback resistors 964 and 963, respectively. As depicted in FIG. 9, the resistor 964 is coupled between the gate of the pMOS transistor 954 and the source of a pMOS transistor 966, which has its drain coupled to the rail 925. The resistor 963 is coupled between a VREF reference voltage and the gate of the pMOS transistor 954. The gate of the pMOS transistor 966 is coupled to the drain of the pMOS transistor 954. A filtering capacitor 962 may be coupled between the drain of the pMOS transistor 954 and ground.

The supply voltage circuit 900 also includes a low pass filter 970, which filters the bias voltage that is provided by the operational amplifier 950 (at the drain of the pMOS transistor 954). In this manner, for the example embodiment that is depicted in FIG. 9, the voltage supply circuit 900 includes a resistor 972 that is coupled between the drain of the pMOS transistor 954 and the gate of a pMOS transistor 982 of an output stage 980 of the supply voltage circuit 900. The filter 970 also includes a capacitor 974 that is coupled between the gate of the pMOS transistor 982 and ground.

As depicted in FIG. 9, in accordance with an example embodiment, the output stage 980 may provide multiple output voltages (VOUT1 and VOUT2, being depicted as examples). In this regard, the VOUT1 and VOUT2 voltages are provided by corresponding pMOS transistor followers, which are formed from pMOS transistors 982 and 988, respectively. In this regard, current sources 984 and 986 provide the source-to-drain currents in the respective pMOS transistors 982 and 988; and the drains of the pMOS transistors 982 and 988 are coupled to the VPUMPD voltage. The sources of the pMOS transistors 982 and 988 provide the VOUT1 and VOUT2 voltages, respectively.

While a limited number of embodiments have been disclosed herein, those skilled in the art, having the benefit of this disclosure, will appreciate numerous modifications and variations therefrom. It is intended that the appended claims cover all such modifications and variations.

What is claimed is:

1. A method comprising:
using a charge pump to receive a first supply voltage and generate a voltage in response thereto; and
using the voltage generated by the charge pump to bias a supply voltage circuit to generate a second supply voltage, the second supply voltage being greater than the first supply voltage.

2. The method of claim 1, wherein using the voltage generated by the charge pump comprises using the voltage generated by the charge pump as a supply voltage for an output stage circuit of the supply voltage circuit.

3. The method of claim 1, wherein using the voltage generated by the charge pump comprises using the voltage generated by the charge pump as a supply voltage for a circuit of the supply voltage circuit to generate a bias voltage for an output stage of the supply voltage circuit.

4. The method of claim 3, wherein using the voltage generated by the charge pump as a supply voltage for the circuit of the supply voltage circuit comprises:
using the voltage generated by the charge pump to bias an amplifier to generate a bias voltage; and
low pass filtering the bias voltage generated by the amplifier to generate the bias for the output stage of the supply voltage circuit.

5. The method of claim 1, further comprising using the charge pump to supply a load current for the supply voltage circuit.

5. The method of claim 1, wherein using the charge pump to generate the voltage comprises using the charge pump to provide a supply voltage for an output stage of the supply voltage circuit, the method further comprising:
using another charge pump to generate a supply voltage for a circuit of the supply voltage circuit to generate a bias voltage for an output stage of the supply voltage circuit.

6. The method of claim 5, further comprising:
using the charge pump that provides the supply voltage for the output stage to provide an output current for the output stage.

7. The method of claim 1, wherein using the charge pump comprises clocking the charge pump with a clock signal, the clock signal transitioning between a low voltage and a high voltage, and the high voltage corresponding to the first supply voltage.

8. An apparatus comprising:
a first charge pump adapted to provide a first voltage;
a second charge pump; and
a supply voltage circuit comprising an output stage circuit to provide an output voltage for supply voltage circuit, the supply voltage circuit adapted to bias the output stage circuit in response to the first voltage and use the second charge pump to provide an output current for the output stage circuit.

9. The apparatus of claim 8, wherein the output stage circuit comprises a source follower circuit comprising a gate to receive a bias voltage in response to the first voltage, a drain coupled to the second charge pump and a source to provide the output voltage.

10. The apparatus of claim 8, wherein the output stage circuit is adapted to receive a supply voltage provided by the second charge pump.

11. The apparatus of claim 8, wherein the supply voltage circuit further comprises:
an amplifier comprising a supply rail to receive the first voltage and an output to provide a bias voltage.

12. The apparatus of claim 11, wherein the supply voltage circuit further comprises:
a low pass filter adapted to filter the bias voltage provided by the amplifier to provide another bias voltage to the output stage.

13. The apparatus of claim 8, further comprising:
at least one additional output stage circuit to provide at least one additional output voltage for the supply voltage circuit, each of the at least one additional output stage circuit adapted to be biased by the supply voltage circuit in response to the first voltage and use the second charge pump to provide an output current for the output stage circuit.

14. The apparatus of claim 8, wherein:
the first charge pump is adapted to boost another voltage to generate the first voltage; and
the second charge pump is adapted to boost the another voltage to provide a supply voltage for the output stage.

15. An apparatus comprising:
an integrated circuit, comprising
a charge pump adapted to boost a first supply voltage to generate a second voltage; and
a supply voltage circuit adapted to be biased in response to the second voltage to generate a second supply voltage greater than the first supply voltage.

16. The apparatus of claim 15, wherein the integrated circuit further comprises another charge pump adapted to provide an output current for the supply voltage circuit in response to the first supply voltage.

17. The apparatus of claim 15, wherein the supply voltage circuit comprises an output stage circuit adapted to provide generate the second supply voltage and an amplifier adapted to generate a bias voltage for the output stage in response to the second voltage.

18. The apparatus of claim 15, wherein the charge pump is adapted to be operated in response to half cycles of a clock signal.

19. The apparatus of claim 15, wherein the supply voltage circuit comprises a plurality of output stage circuits adapted to provide a plurality of supply voltages including the first supply voltage.

20. The apparatus of claim 15, wherein the integrated circuit further comprises a processor core.
